(19) United States
(12) Patent Application Publication
(10) Pub. No.: US 2024/0182331 A1
(43) Pub. Date: Jun. 6, 2024

(54) Electrode Deionizer

(71) Applicants: Board of Trustees of Michigan State University, East Lansing, MI (US); Fraunhofer USA, Plymouth, MI (US)

(72) Inventors: Qi Hua FAN, Okemos, MI (US); Keliang WANG, Okemos, MI (US)

(73) Assignees: Board of Trustees of Michigan State University, East Lansing, MI (US); Fraunhofer USA, Plymouth, MI (US)

(21) Appl. No.: 18/403,914

(22) Filed: Jan. 4, 2024

Related U.S. Application Data
(63) Continuation-in-part of application No. 17/431,989, filed on Aug. 18, 2021.
(60) Provisional application No. 62/807,797, filed on Feb. 20, 2019.

(51) Int. Cl. C02F 1/469; C02F 101/36; C02F 103/02

(52) U.S. Cl. CPC C02F 1/4696; C02F 2101/36; C02F 2103/02; C02F 2201/483; C02F 2307/06

(57) ABSTRACT

An electrode deionizer and method remove polarized molecules of an ionic cluster in a fluid. In another aspect, electrophoresis and dielectrophoresis forces are used between electrodes to move a polarized molecular cluster in an electric field, which are then trapped in an activated-carbon on an anode. A further aspect uses dielectrophoresis to reduce the size of polarized molecules of an ionic cluster in a fluid. Yet another aspect of the present apparatus and method employ RF power in addition to DC power.

### CROSS-REFERENCE TO RELATED APPLICATIONS

This application is a continuation-in-part of U.S. patent application Ser. No. 17/431,989, filed on Aug. 18, 2021, which is a national phase entry of international patent application Serial No. PCT/US2020/018585, filed on Feb. 18, 2020, which claims the benefit of U.S. provisional application Ser. No. 62/807,797, filed on Feb. 20, 2019. The entire disclosures of the above applications are incorporated by reference herein.

### GOVERNMENT RIGHTS

This invention was made with government support under 1700785, 1700787, and 1724941 awarded by the National Science Foundation. The government has certain rights in the invention.

### BACKGROUND AND SUMMARY

Per-and-polyfluoroalkyl substances (“PFAS”) are a group of man-made chemicals that are very persistent in the environment and human body, which can lead to adverse human health effects. PFAS molecules have been commonly used as stain repellants and fire-fighting foams which were emitted into the air and water by industrial processes used to manufacture fluoro chemicals. PFAS molecules have also entered the ground and surface water through disposal of waste and sewage sludge, and as a result of fire-fighting use.

U.S. Patent Publication No. 2018/0222781 is entitled “Water Purification using Porous Carbon Electrode” which published to Liu et al. on Aug. 9, 2018. This patent publication is incorporated by reference herein. This device uses an electrolysis chemical reaction process to break contaminants into small and stable molecules by using an electric current flowing between parallel electrodes.

Furthermore, U.S. Patent Publication No. 2014/0210344, entitled “Water/Wastewater Recycle and Reuse with Plasma, Activated Carbon and Energy System” which published to Foret on Jul. 31, 2014, employs a glow discharge cell, a plasma torch and electrodes. Another system is disclosed in U.S. Pat. No. 9,776,894 entitled “Apparatus for Purifying a Fluid and Method for the Attainment Thereof” which issued to Servida on Oct. 3, 2017; this provides spiral wound electrode and spacer layers. However, these systems do not use dielectrophoresis, among other significant differences. This patent publication and patent are incorporated by reference herein.

In accordance with the present invention, an electrode deionizer and method remove a polarized molecule and/or an ionic cluster in a fluid. In another aspect, electrophoresis and dielectrophoresis forces are created between electrodes to move polarized molecular and ionic clusters in an electric field, which are then trapped in an activated-carbon on an electrode. A further aspect uses dielectrophoresis to reduce the size of a polarized molecule and/or an ionic cluster in a fluid. Yet another aspect of the present apparatus and method employ RF power in addition to DC power to the electrodes to assist with dielectrophoresis and/or size reduction of ionic clusters. A replaceable cartridge within which are an activated-carbon electrode and a counter electrode, and a fluid flowing path therebetween, is also provided. In still another aspect, an electrode deionizer apparatus and method include an electrode having multiple spaced apart and substantially parallel electrically conductive wires, an active electrode having an elongation direction offset oriented from an elongation direction of the wires, a DC power supply connected to the active electrode, and optionally, an RF power supply connected to the active electrode.

In accordance with the present invention, an electrode apparatus and method remove a polarized molecule in a fluid. In another aspect, an electric potential is applied to an anode located within the fluid, the fluid flows within a gap between the anode and a surrounding cathode, and a non-uniform electric field is created between the anode and the cathode. A further aspect causes a polarized molecule in a liquid or gaseous fluid to move toward an anode. In another aspect, an electrically conductive porous material is an anode and is circumferentially surrounded by a grounded cathode with a fluid flowing therebetween and a polarized molecule in the fluid is driven toward the anode, without causing electric current flowing between the anode and cathode and/or without a chemical reaction to the polarized molecule. In a further aspect, an anode is made of a porous metal and/or a porous activated carbon.

Moreover, another aspect includes a method for manufacturing an anode including making a metallic foil sheet, which may be a porous metal foam, attaching an activated carbon layer to the foil sheet and coiling or bending the foil and activated carbon assembly into a generally cylindrical shape. This method may further include applying an electric field between the foil/carbon anode and a surrounding cathode, flowing a liquid or gaseous fluid between the anode and the cathode, and electrically pulling polarized molecules to the anode without causing an electric current to flow. A further aspect of the present apparatus and method includes a drinking water faucet to which the anode and cathode are attached. Yet another aspect of the present apparatus and method uses the anode and cathode as part of an industrial water fluid treatment piping system. Additional advantages and features will be disclosed in the following description and appended claims, taken in conjunction with the accompanying drawings.

### BRIEF DESCRIPTION OF THE DRAWINGS

FIG. 1 is a diagrammatic view showing an industrial water treatment apparatus employing the present electrode apparatus;

FIG. 2 is a longitudinal-sectional view, taken along line 2-2 of FIG. 1, showing the present electrode apparatus;

FIG. 3 is a diagrammatic view showing the present electrode apparatus of FIG. 2;

FIG. 4 is a cross-sectional view, taken along line 4-4 of FIG. 3, showing the present electrode apparatus;

FIG. 5 is a model of a PFAS molecule employed with the present electrode apparatus;

FIG. 6 is a perspective view showing a drinking water faucet apparatus employing the present electrode apparatus;

FIG. 7 is a longitudinal-sectional view, taken along line 7-7 of FIG. 6, showing the present electrode apparatus;

FIG. 8 is a series of perspective views showing a first manufacturing process to make an anode used in the present electrode apparatus;

FIG. 9 is a cross-sectional view, taken along line 9-9 of FIG. 8, showing the anode used in the present electrode apparatus;

FIG. 10 is a series of perspective views showing a second manufacturing process to make the anode of the present electrode apparatus;

FIG. 11 is a cross-sectional view, taken along line 11-11 of FIG. 10, showing the anode of the present electrode apparatus;

FIG. 12 is a series of perspective views showing a third manufacturing process to make the anode of the present electrode apparatus;

FIG. 13 is a cross-sectional view, taken along line 13-13 of FIG. 12, showing the anode of the present electrode apparatus;

FIG. 14 is a graph showing a Zeta potential of biochar used in the anode of the present electrode apparatus;

FIG. 15 is a diagrammatic side view showing another embodiment of the present electrode apparatus;

FIG. 16 is a diagrammatic top view showing the present electrode apparatus of FIG. 15;

FIG. 17 is a diagrammatic top view showing the present electrode apparatus of FIG. 15, in a reversed voltage condition from that in FIG. 16;

FIG. 18 is a circuit diagram showing the present electrode apparatus of FIG. 15, for electro-active adsorption;

FIG. 19 is a graph showing different adsorption capacities for the present electrode apparatus of FIG. 15;

FIG. 20 is a diagrammatic view showing an exemplary water molecule acted upon by the present electrode apparatus of FIG. 15;

FIG. 21 is a diagrammatic view showing exemplary ion-water molecule clusters acted upon by the present electrode apparatus of FIG. 15;

FIGS. 22 and 23 are graphs showing bonding energies at 0.24 eV and 0.12 eV for the first and second layer of water molecules, respectively, of ion-water clusters for the present electrode apparatus of FIG. 15;

FIG. 24 is a diagrammatic view showing an electrophoresis force in a uniform electrical field;

FIG. 25 is a diagrammatic view showing ions experiencing an electrophoresis force and dipoles experiencing a dielectrophoresis force, in a non-uniform electrical field the present electrode apparatus of FIG. 15;

FIG. 26 is a diagrammatic view showing an ion-water cluster experiencing electrophoresis and dielectrophoresis forces, in a non-uniform electrical field in the present electrode apparatus of FIG. 15;

FIGS. 27A and B are diagrammatic views showing ionic clusters having a large size (FIG. 27A) in a uniform electric field and a reduced size (FIG. 27B) acted upon by the present electrode apparatus of FIG. 15;

FIGS. 28 and 29 are diagrammatic views showing ionic cluster drift in a uniform electric field generated by two parallel-plate electrodes (FIG. 28) and a dielectrophoresis enhanced ion drift (FIG. 29), using the present electrode apparatus of FIG. 15;

FIGS. 30-32 are diagrammatic views showing a PFAS ion-water cluster structure (FIG. 30), which has a large hydration volume in a uniform electric field generated by two parallel-plate electrodes (FIG. 31) and a reduced hydration volume, in the present electrode apparatus of FIG. 15, enhancing the cluster drift mobility;

FIG. 33 is a longitudinal-sectional view showing another embodiment of the present electrode apparatus;

FIG. 34 is a cross-sectional view showing another embodiment of the present electrode apparatus;

FIG. 35 is a diagrammatic top view showing another embodiment of the present electrode apparatus;

FIGS. 36 and 37 are diagrammatic views showing another embodiment of the present electrode apparatus;

FIG. 38 is a diagrammatic view showing another embodiment of the present electrode apparatus; and

FIG. 39 is a diagrammatic view showing another embodiment of the present electrode apparatus.

### DETAILED DESCRIPTION

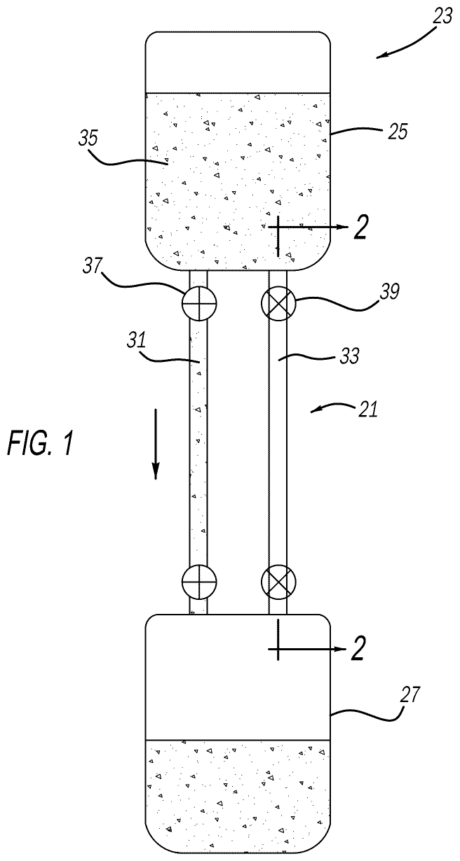

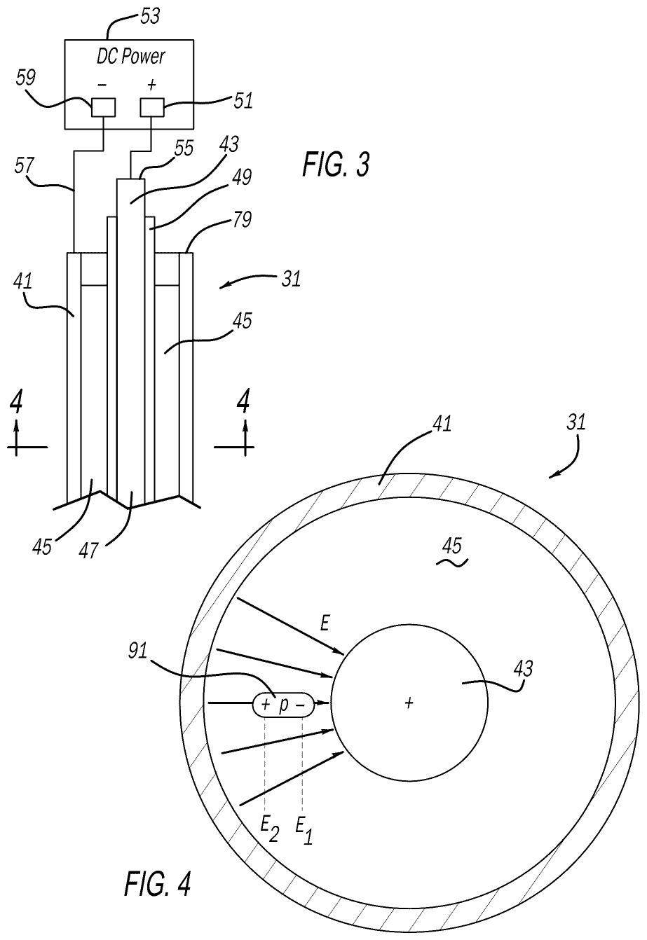

A first preferred embodiment of an electrode apparatus 21 used in an industrial water treatment system 23 is illustrated in FIGS. 1-4. Water treatment system 23 includes a contaminated water supply reservoir or tank 25, a decontaminated water receiving or holding reservoir or tank 27, and one or more electrode-based precipitator or treatment units 31 and 33. Valves 37 of treatment unit 31 are turned on to allow flow of contaminated water 35 between the tanks while valves 39 of treatment unit 33 may be optionally turned off to stop fluid flow therein, or vice versa, for example if an anode therein needs to be cleaned and/or replaced. Additionally, water pumps, sensors, pipes and other plumbing components may be employed to flow water 35 from tank 25, through treatment units 31 and/or 33, and to tank 27.

More specifically, each precipitator and treatment unit 31 and 33 includes a longitudinally elongated and generally cylindrically shaped cathode electrode 41 which concentrically surrounds a generally cylindrically shaped and longitudinally elongated anode electrode 43 internally located therein. A cylindrical gap 45 concentrically surrounds anode 43 between an outer diameter periphery of the anode and an inner diameter surface of cathode 41, such that the cathode and anode are spaced away from each other to allow water 35 to longitudinally flow in gap 45. The anode preferably has an outer diameter less than half of the inner diameter of the cathode although such a relationship may be varied for different uses.

Anode 43 is preferably a conductive and corrosion resistant rod material 47 with porous structures. Anode 43 can be a metal, such as copper, stainless steel, nickel or an alloy thereof. Alternatively, anode 43 consists of a metal core 47 with a layer of activated carbon 49 on an outside thereof. Activated carbon 49 is preferably treated as is disclosed in PCT International Patent Publication No. WO 2018/136502 entitled “Magnetic Field Enhanced Plasma for Materials Processing” which published to one of the present co-inventors Qi Hua Fan, on Jul. 26, 2018, and U.S. Pat. No. 9,754,733 entitled “Method for Plasma Activation of Biochar Material” which also issued to co-inventor Qi Hua Fan, on Sep. 5, 2017, both of which are incorporated by reference herein. Activated carbon layer 49 has a thickness of at least 1 micron and a surface area greater than 600 m²/g is preferred. For PFAS adsorption, it is preferred to employ plasma activated carbon with a relatively positive surface potential. Furthermore, cathode 41 is a conductive, corrosion resistant and tubular metallic material, preferably copper but alternately stainless steel, nickel or an alloy thereof.

An electrical circuit 51 electrically connects a direct current power source 53 to an end 55 of anode 43 for supplying positive dc voltage thereto. The preferred voltage range is 1-100 volts and more preferably 3-40 volts, however, greater voltage can be used with other fluids. Another electrical circuit 57 electrically couples an end of cathode 41 to a ground 59. Due to the non-symmetrical nature of the electrodes, for example the fluid-exposed surface area size differences between the smaller outer diameter of anode 43 and the larger inner diameter of cathode 41, a non-uniform electric field is created within gap 45. Although there are electrical potential differences between anode 43 and cathode 41, however, essentially no electrical current flows between these electrodes since the fresh water within gap 45 is a poor electrical conductor and essentially acts as an insulator. There is no current flow corresponding to the transport of PFAS. Thus, there is no electrical current between the electrodes in the water assuming no impurities in the water other than the polarized contaminants to be removed.

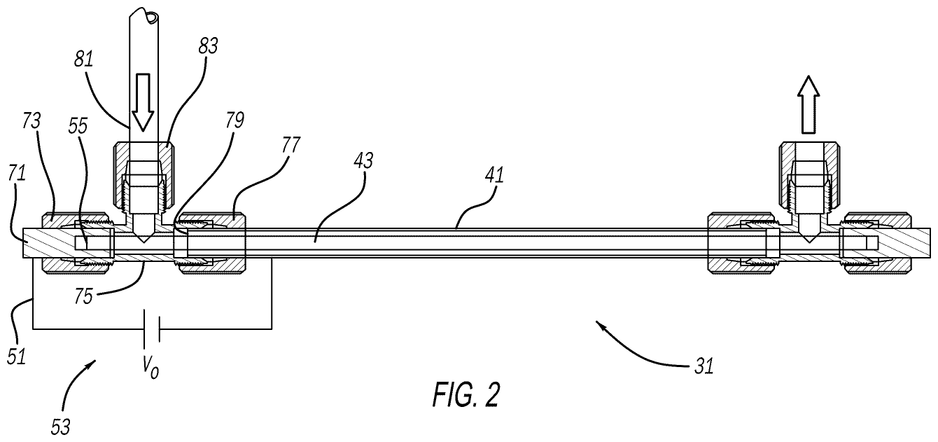

As can best be observed in FIG. 2, an electrical connector 71 retains the associated end 55 of anode 43 within an end-fitting 73. In the present example, end fitting 73 is threadably coupled to a T-pipe junction 75. Furthermore, an intermediate fitting 77 threadably couples an associated end 79 of cathode 41 to pipe junction 75. An additional pipe or contaminated water supply line 81 is coupled to pipe junction 75 via another fitting 83. A similar arrangement is provided on the opposite end of the treatment unit 31. It should be appreciated that the cathode and anode longitudinal lengths and lateral diameters, as well as the flow through area of the gap therebetween, is sized to match the fluid flow rate, the concentration of the polarized molecule contaminants to be removed, and the adsorption capabilities of the anode employed. Regardless, it is envisioned that the longitudinal length of anode 43 will be at least ten times and more preferably at least twenty times an outer diameter thereof.

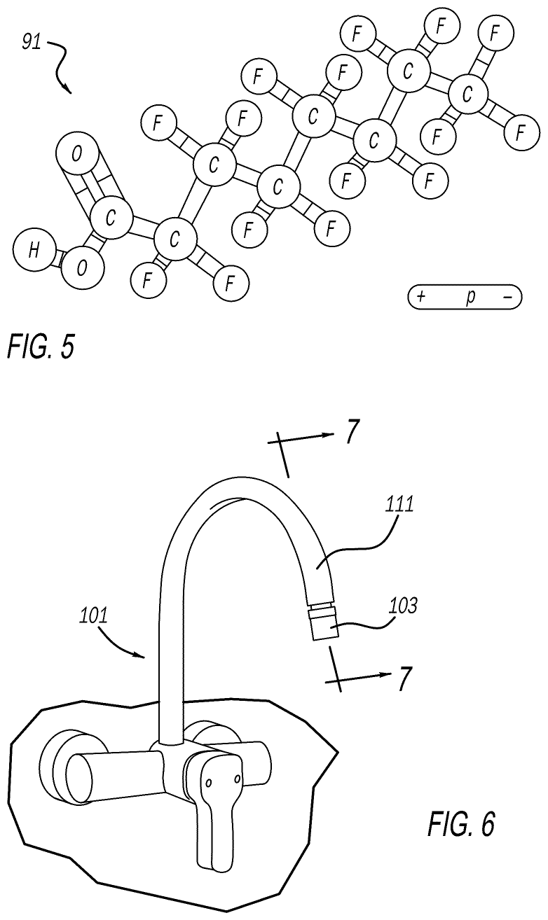

Referring now to FIGS. 4 and 5, the contaminant to be removed by the present electrode apparatus and method is a polarized molecule 91, preferably a PFAS molecule consisting of at least carbon and fluorine atoms. E denotes the non-uniform electric field between anode 43 and cathode 41 which drives or pulls the polarized molecule 91 toward anode 43 which is then adsorbed into the porous anode. It is noteworthy that no chemical reaction or electrolysis is occurring to molecules 91 since no or minimal electrical current is flowing between the electrodes. Thus, anode serves to remove the polarized molecule contaminants from the water as the water flows past the anode. No additional filtering or chemical reactions should be necessary to remove these polarized molecules from the flowing drinking water. Periodically, the contaminant-rich anode will be removed and either replaced or cleaned.

It is alternately envisioned that polarized molecules other than PFAS may be removed by use of the present electrode apparatus and method. Moreover, polarized molecules may alternately be removed from other liquid and gaseous fluids, such as within a combustion smokestack or exhaust pipe. Other polarized molecule contaminants include benzene, carbon dioxide, sulphur dioxide and the like.

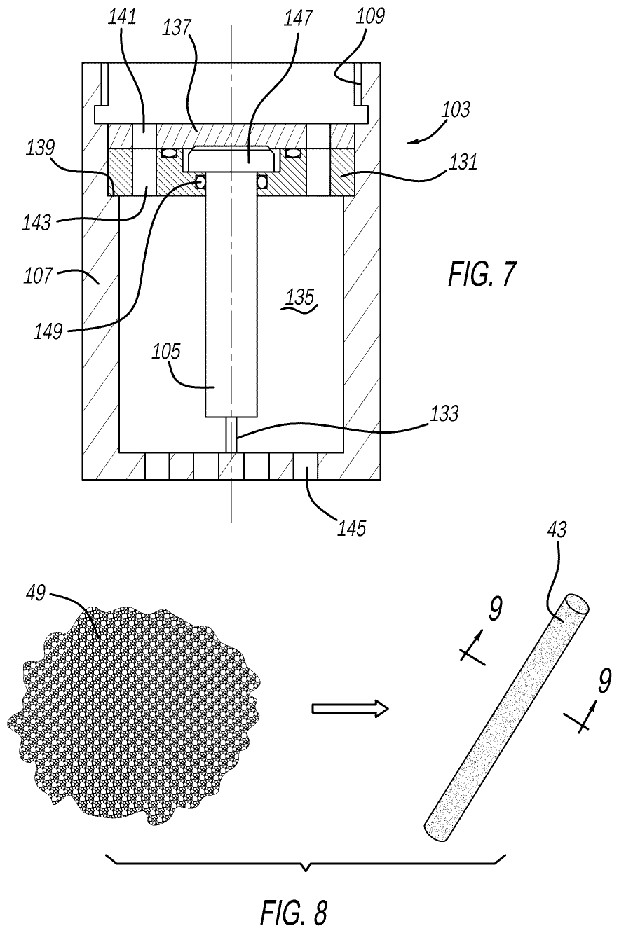

A residential implementation of an exemplary second preferred embodiment of the present electrode apparatus and method are illustrated in FIGS. 6 and 7. A residential drinking water faucet 101 includes an adapter 103 adjacent a distal end thereof. Adapter 103 employs an anode electrode 105 and a concentrically surrounding cathode electrode 107, both of which are longitudinally elongated. A threaded coupling 109 removeably couples a proximal end of cathode 107 to an outlet pipe 111 of faucet 101. Furthermore, a pair of polymeric insulators 131 and 133 mount and insulate anode 105 within cathode while allowing a water flow gap 135 between the facing outer and inner surfaces of anode 105 and cathode 107, respectively. A polymeric cover plate 137 is also provided to secure insulator 131 within a stepped recess 139 of cathode 107. Cover plate 137 may be attached to the inside of the cathode by threads, adhesive or an interference press-fit. Cover plate 137 includes multiple longitudinally open holes 141, insulator 131 also includes multiple aligned and longitudinally accessible holes 143, and a distal end of cathode 107 additionally includes longitudinally accessible holes 145, to allow drinking water to flow therethrough. A battery power supply 147 is electrically connected to anode 105 and may be retained between insulator 131 and cover plate 137, or in a remote different location with a wire or stamped circuit, to supply electrical voltage to an end of anode 105. O-rings 149 are also employed to seal the various components. The anode and cathode function essentially the same as with the prior industrial configuration for removing polarized molecule contaminants from the drinking water and adsorbing them onto the anode.

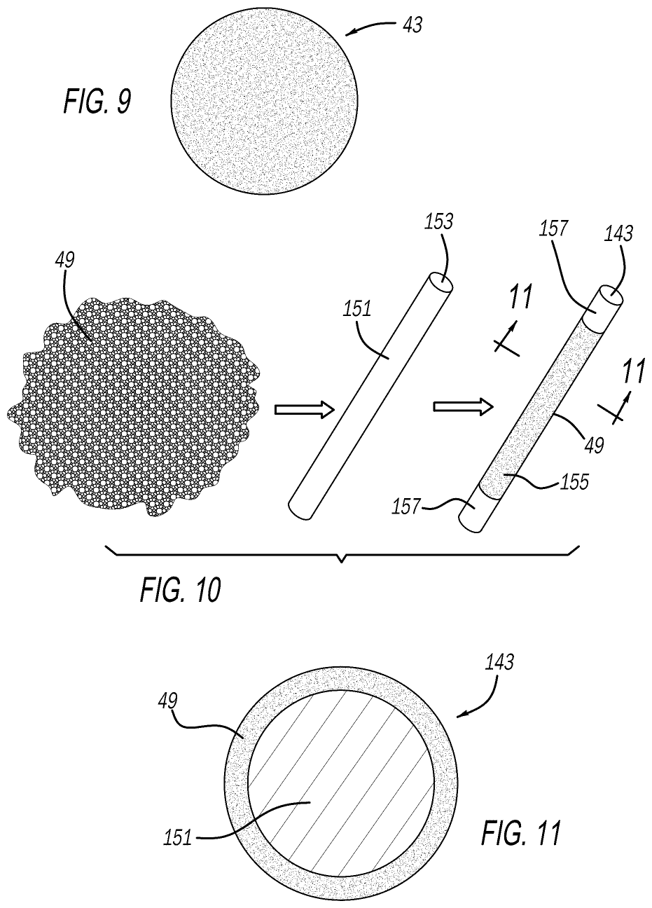

A first method of manufacturing and structure of the present anode 43 is shown in FIGS. 8 and 9. Plasma activated carbon 49 includes a binder material and is pressed and heated to form a unitary and uniform, solid rod with the activated carbon and binder composition evenly spread throughout the entire cross-sectional area from end-to-end. FIGS. 10 and 11 show another manufacturing process and construction of an anode 143 wherein a layer of activated carbon 49, intermixed with a binder material, is coated or otherwise affixed to an outer diameter surface 151 of a conductive and corrosion resistant metallic rod 153, such as copper, stainless steel, nickel or an alloy thereof, which has a generally circular-cylindrical and longitudinally elongated shape. Preferably, the coated rod assembly of anode 143 is only coated at a middle area 155 of rod 151 such that end sections 157 do not have activated carbon 49 thereon. This advantageously allows easier and more effective electrical coupling of the uncoated end sections 157 to the electrical connector.

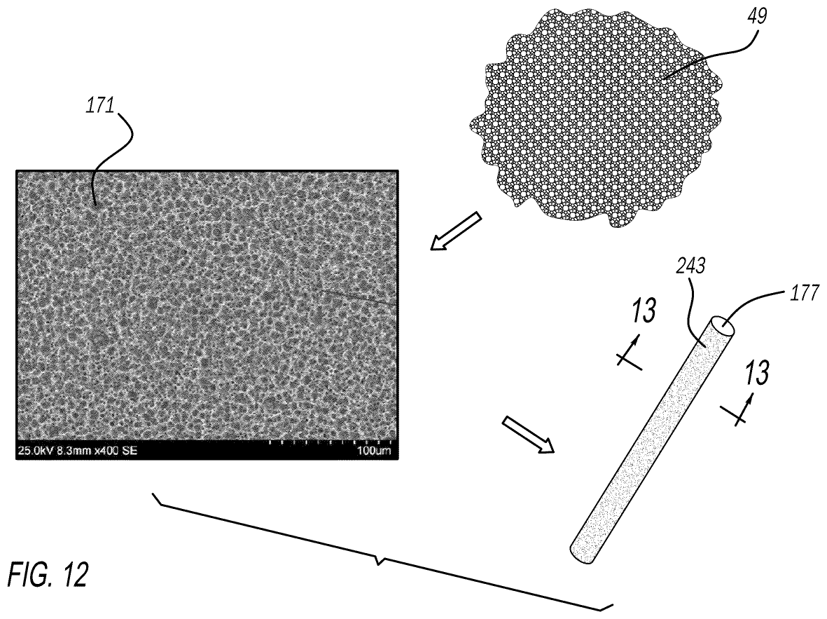

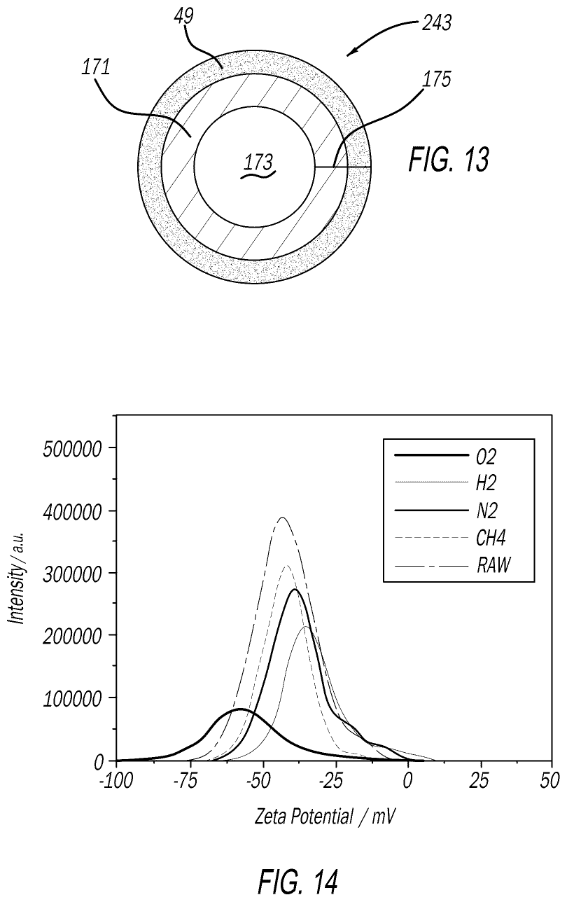

A third manufacturing process and configuration for anode 243 can be observed in FIGS. 12 and 13. First, a foamed metallic sheet or foil 171 is provided. Foamed foil 171 is preferably a nickel foam with a surface density of about 346 g/m² and a porosity greater than or equal to 95 percent, with 80-110 pores per inch and an average hole diameter of about 0.25 mn. One such nickel foam foil can be obtained from MTI Corporation. It should be appreciated, however, that other metallic foam or, less preferably, unfoamed metallic sheets may be employed.

Activated carbon material, preferably intermixed with a binder, is then deposited, coated or otherwise attached to an outer porous surface of metallic foam foil 171 in a generally flat state. In one example, activated carbon 49 is mixed into a slurry and pressed into the open pores of metallic foam foil 171, which is in a flat state. The assembled activated carbon slurry and foam is then heated at approximately 60-100° C. to dry. An exemplary binder maybe of a cellulose type. Subsequently, the foil and activated carbon assembly is then coiled, rolled or bent into a circular-cylindrical shape with a hollow center 173 with an edge seam 175 attached together to form a complete cross-sectional circle. Optionally, end caps 177 are fastened to both opposite ends of the coiled anode 243 to prevent fluid flow through the hollow center 173. Any of these anode configurations 43, 143 and 243 may be interchangeably used in any of the industrial or residential apparatuses disclosed herein.

FIG. 14 illustrates a zeta potential of the activated carbon. Use of different plasma gas precursors such as CH₄, O₂H₂ and N₂ may be employed in the plasma activation of the carbon to efficiently modulate the surface electropotential of the activated carbon and facilitate contaminant molecule absorption. This allows for tuning or shifting of the surface area potential of the activated carbon so it can be tailored for specific contaminant materials to be absorbed most effectively. In the present example, the use of H₂ during the plasma activation is best suited for PFAS adsorption into the anode in the present apparatus.

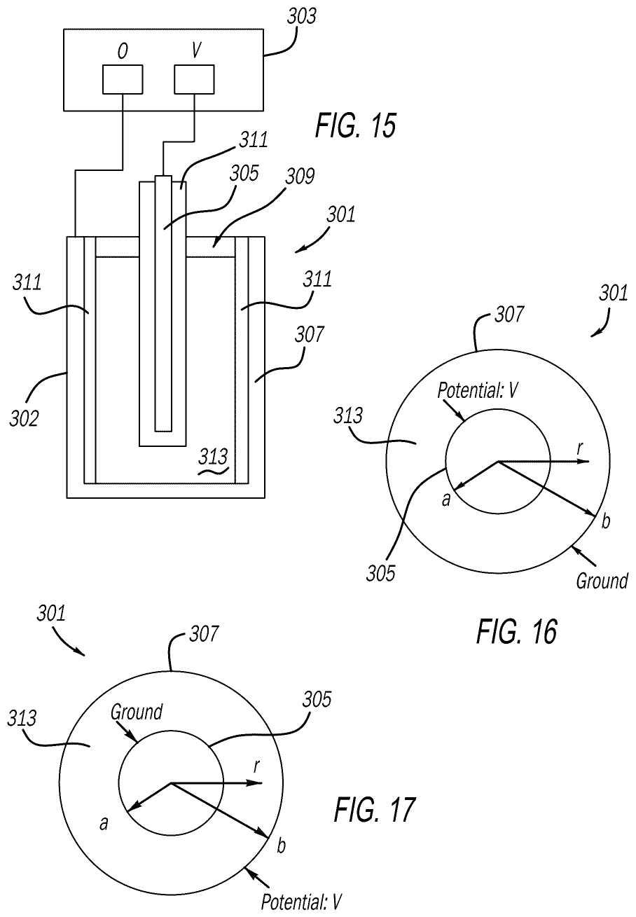

Turning now to FIGS. 15-18, another embodiment of an electrode apparatus includes an electrode deionizer 301 which creates dieletrophoresis enhanced deionization. In the illustrated configuration, the present deionizer employees electro-active adsorption using a coaxial electrode assembly within a static batch tank 302. Such a static batch tank is ideally suited for removing undesired molecules from a fluid such as heavy metals from concentrated wastewater.

A DC power source 303 is electrically connected to a central and longitudinally elongated anode electrode 305. A cathode, also known as a ground electrode, 307 is concentrically spaced away from and surrounds anode 305, with a gap 309 therebetween. The anode, and optionally an inside surface of the cathode, are coated with a plasma-activated carbon 311, such as activated biochar. The anode and biochar can be constructed as previously discussed hereinabove. An anion liquid solution 313 is located within the gap, and contains the ion-induced polarized molecular cluster, also known as ionic clusters, therein. One such cluster is PFAS-water.

The electrical field potential V and ground effects between anode 305 and cathode 307 are shown in FIGS. 16 and 17. A non-uniform electric field is created therebetween. The apparatus creates electrophoresis forces between the anode and the cathode to cause ionic cluster in the fluid to move to the anode and also creates dielectrophoresis forces on dipoles of the polarized molecular cluster. The graph of FIG. 19 illustrates expected adsorption capacities of: (a) traditional soaking of an ionic solution with a single flat carbon electrode; (b) conventional capacitive deionization (“CDI”) using parallel flat electrodes in an ionic solution; (c) the present apparatus 301 employing electro-active adsorption (“EAA”) with coaxial electrodes in a nonuniform electric field; all setting V₀=1.2 volts.

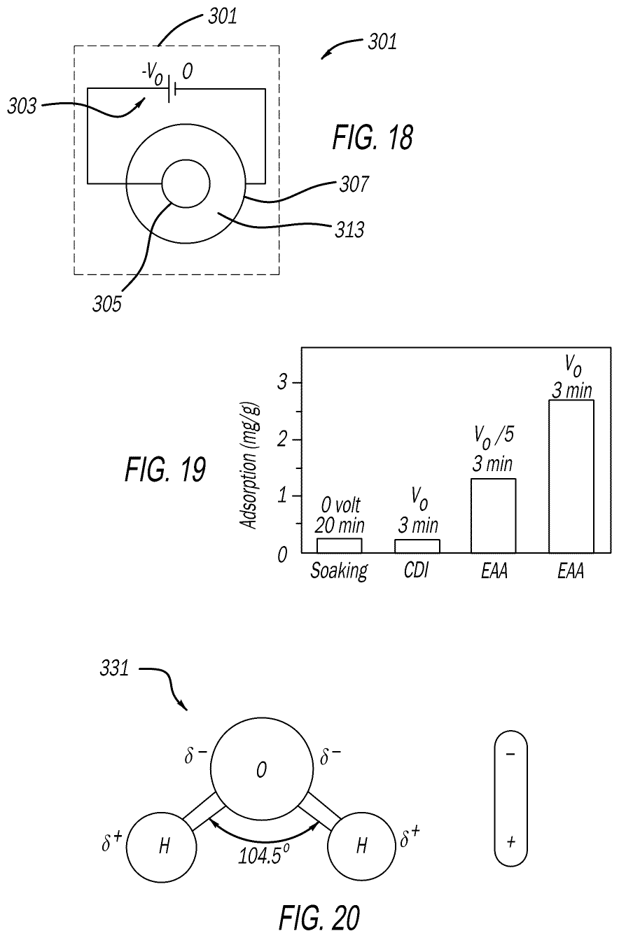

The electric potential applied to center electrode 305 can be negative relative to ground electrode 307, as shown in FIG. 18. This embodiment allows the capture of cations that possess positive charges and form ion-water clusters.

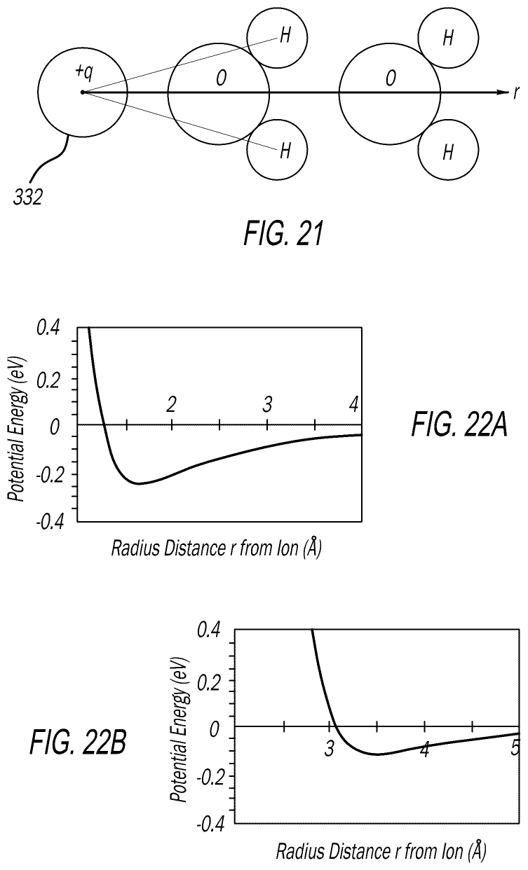

Reference should be made to FIGS. 20-32 for an understanding of the ionic chemistry. A water molecule 331 of FIG. 20 in the liquid solution is highly polarized with a large intrinsic dipole moment. The bonding energy of ion-water clusters, illustrated in FIG. 21, are significant and difficult to break. The graphs of FIGS. 22A and 22B demonstrate the potential energy versus radius distance ‘r’ from the ion in FIG. 21. For example, at room temperature, the thermal energy of kT is approximately 0.026 eV, wherein the potential energy of a first layer is 0.24 eV and of a second layer is 0.12 eV. Many additional layers are often present in stable ion-water clusters. Ions, such as Na⁺ 333, dissolved in the water form large clusters 335, as is shown in FIGS. 21, 27A and 30. In their natural state, these large ionic clusters move slowly in the liquid even under an electrical field.

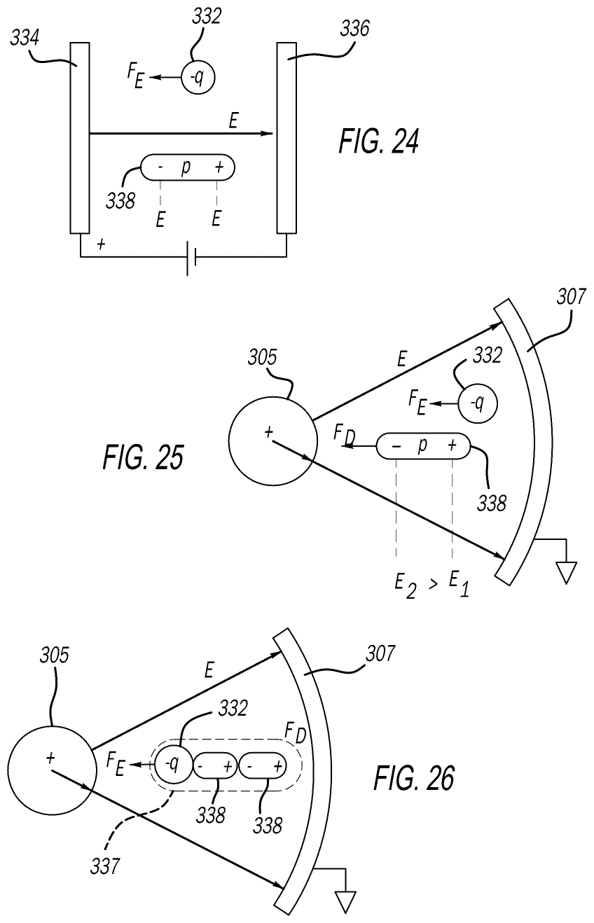

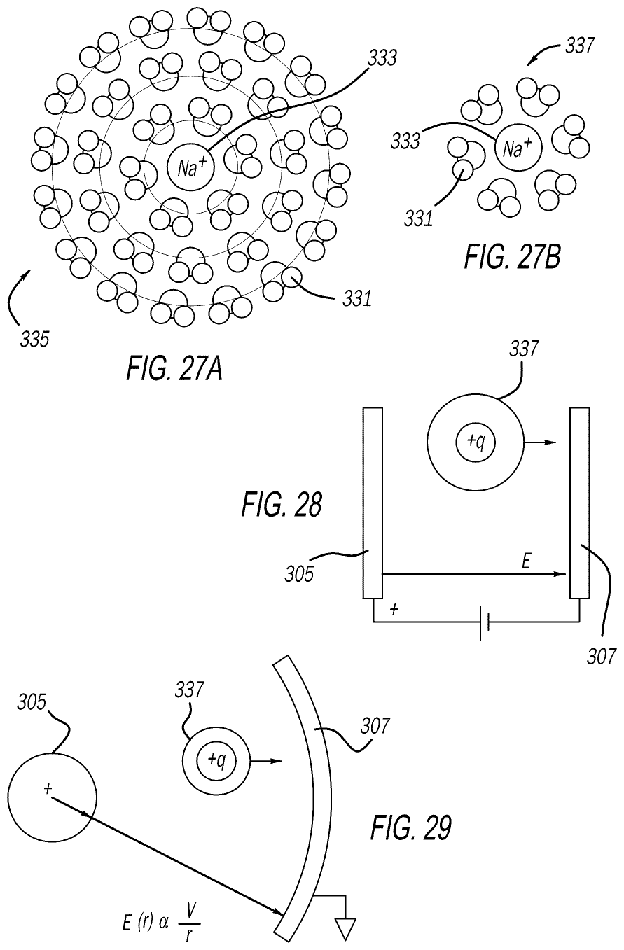

In a uniform electrical field E, like that illustrated in FIG. 24, only ions 332 experience an electrophoresis force between a working electrode 334 and a ground electrode 336. However, in a non-uniform electrical field E₂>E₁ of the present apparatus, represented in FIGS. 25 and 26, ions 332 experience an electrophoresis force FE and dipoles 338 experience a dielectrophoresis force FD. This combination of electrophoresis and dielectrophoresis is optionally used by the present deionizer to reduce a size of the polarized molecular cluster from the large cluster 335 shown in FIG. 27A to a reduced size cluster 337 shown in FIG. 27B.

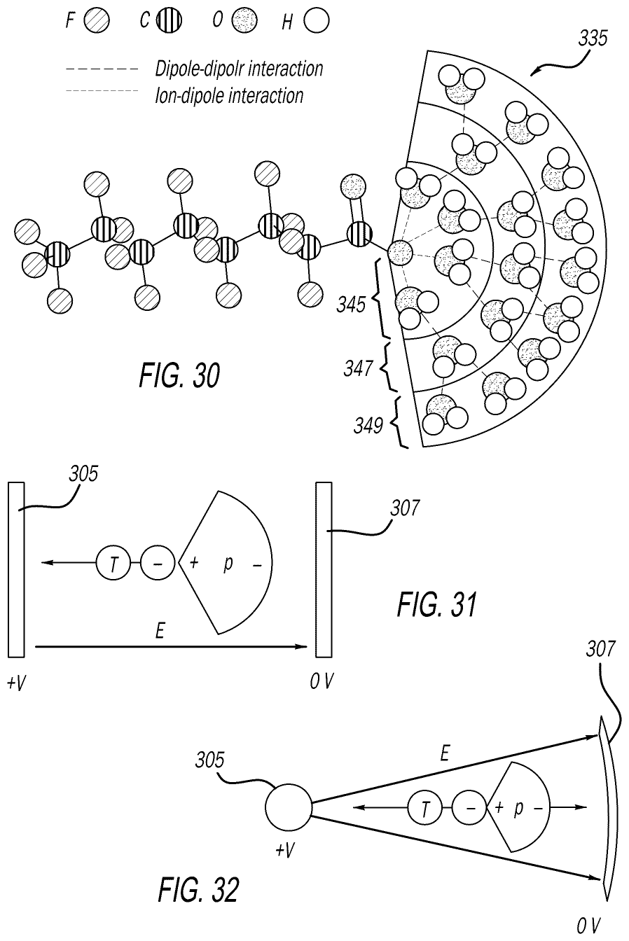

The dielectrophoresis force removes outer layer water molecules from the large cluster while the non-uniform electric field enhances ion drift. This is illustrated in FIGS. 30-32 where exemplary ion-dipole interaction and a dipole-dipole interaction between a PFAS ion and water molecules are shown for an inner hydration region 345, an outer hydration region 347 and a bulk water region 349. With reference to FIGS. 28 and 29, ion-water clusters 337 with a reduced size in a non-uniform electrical field are more easily moved within the liquid and then trapped in the activated carbon on anode 305, or on cathode 307, depending on the ion charge being positive or negative. In other words, the system advantageously experiences faster adsorption and higher ion trapping capacity due to the smaller ion-water clusters. This functionality of the present electrode apparatus is highly beneficial for dielectrophoresis enhanced adsorption of PFAS, Chlorine, Cesium, Lithium, Sodium, and the like.

Optionally, the present electrode deionizer apparatus additionally employs radio frequency (“RF”) power to anode 305 of any of the embodiments disclosed herein. This is in addition to and simultaneous with the DC power to the anode. The RF power enhances the dielectrophoresis effects in the cluster size reduction, although it consumes more energy. The preferred RF peak voltage is 10-1,000 V and more preferably 100-1,000 V, and most preferably approximately 100 V. An exemplary RF frequency is greater than 100 KHz. The preferred DC voltage is 1.2-5 V when used in combination with RF power.

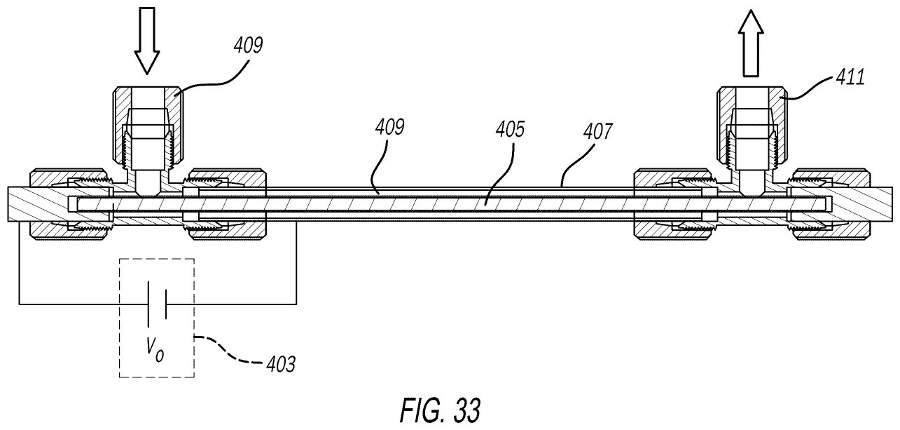

Another embodiment of the present electrode deionizer apparatus and method can be observed in FIG. 33. This is similar to the FIG. 2 configuration, except a DC+RF power supply 403 sends both DC and RF power to a longitudinally elongated anode 405 which is concentrically located within and spaced away from a surrounding fluid-carrying cathode 407. Liquid, such as water, continuously flows through a gap 409 between the electrodes. The liquid flows in an inlet 409 and exists an outlet 411. This arrangement is well suited as a flow reactor for treating large volumes of low impurity concentration water, such as brackish water. The non-uniform electric field and electrophoresis and dielectrophoresis features and functionality of the FIG. 15 embodiment are also applicable to the FIG. 33 version.

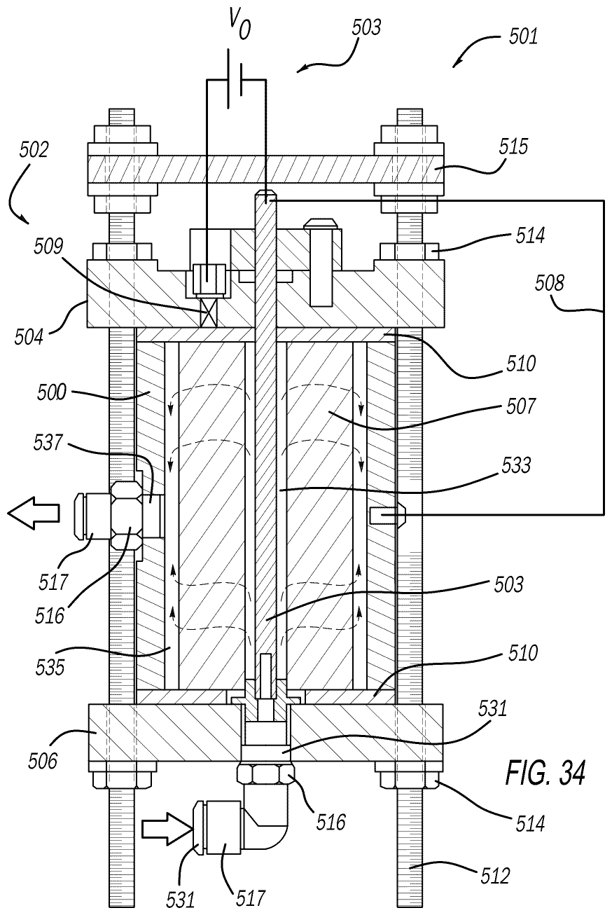

FIG. 34 illustrates present electrode deionizer apparatus 501 and method but in a removable and self-contained cartridge assembly 502. Cartridge 502 includes an outer housing 500, a top cover 504 and a bottom cover 506, within which are a central electrode 505 and a concentric electrode 507. An electrical circuit includes a DC and optionally RF power supply 503, connected to the electrodes via screws that push a spring for each electrode contact 509, or the like. Another optional electrical circuit 508 acts as a ground potential connector between the center electrode and a housing if metal.

Elastomeric gaskets 510 are located between the covers and housing. Furthermore, removable fasteners, such as threaded bolts 512 and nuts 514, provide mounting of the cartridge to a bracket 515, and threaded fitting 516 attachment to adjacent fluid-carrying pipes 517 of the stationary system. This allows for disassembly and replacement thereof with a similarly configured second cartridge.

This cartridge configuration flows water containing the ionic molecular clusters in flow paths entering an inlet 531, along a gap 533 between activated carbon coated electrode 503 and electrode 507, through activated carbon pores of electrode 507, along an outer gap 535 between cathode and housing 502, and finally exiting an outlet 537. The electrodes are preferably a plasma-activated carbon material having a porosity of 20-60%. Cartridge-based electrode deionizer 501 advantageously creates a non-uniform electric field as well as electrophoresis and dielectrophoresis to reduce the size of and move the ionic molecules for trapping by the activated carbon electrode(s). The cartridge may be used in an industrial water management piping system or a residential piping system, for example, being removably attached to a freshwater faucet.

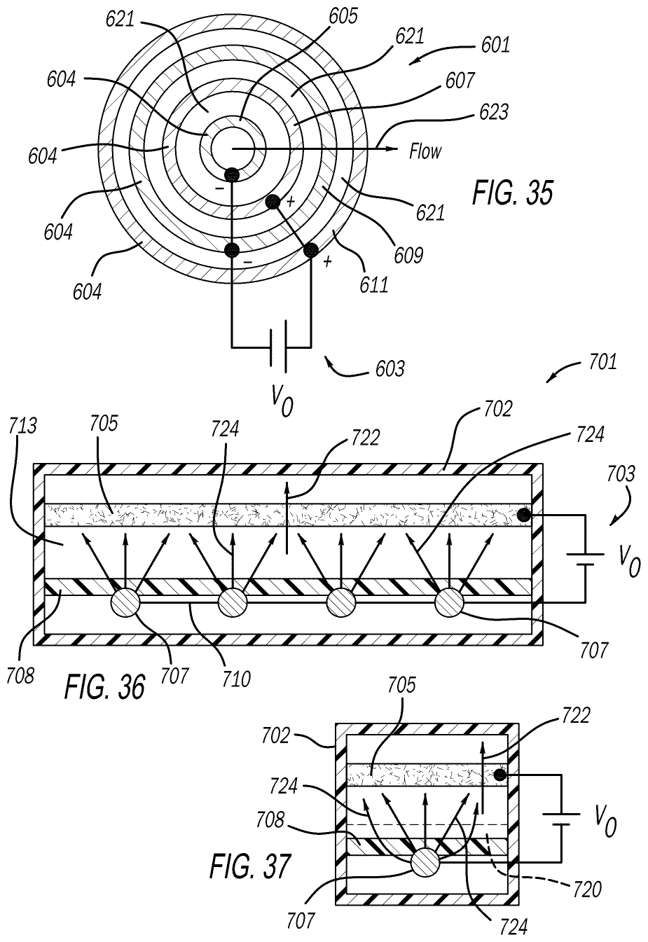

A multiple coaxial electrode deionizer apparatus 601 is shown in FIG. 35. A DC and optionally, RF, power supply 603 are electrically connected to porous and plasma-activated carbon (e.g., biochar) electrodes 604. In particular, the electrodes include concentric cathodes 605 and 609, alternating with concentric anodes 607 and 611. There are at least two absorbing electrodes (e.g., 607 and 609) made of activated carbon, which are electrically connected to opposite potentials. Thus, there are at least two cylindrical anodes and at least two cylindrical cathodes, all being longitudinally elongated and coaxial. A fluid, such as water, flows longitudinally within gaps 621 between the electrodes and also in a generally lateral direction 623 through pores in the carbon of the electrodes (much like in the cartridge construction discussed hereinabove).

The electrical field is in primarily lateral directions between the electrodes in the present multiple coaxial version. This configuration advantageously removes both positive and negative ions in a single unit, and can absorb more ions by use of the many concentric activated carbon electrodes. This electrode deionizer 601 advantageously creates a non-uniform electric field as well as electrophoresis and dielectrophoresis to reduce the size of and move the ionic molecules for trapping by the activated carbon electrodes. The present embodiment may be used in an industrial water management piping system or more preferably, in a residential piping system, for example, being removably attached to a freshwater faucet, and either in a removable cartridge or in a more integral arrangement.

Referring to FIGS. 36 and 37, another embodiment of the present electrode deionizer apparatus 701 includes an outer housing 702, such as a batch tank or continuous flow pipe, and a DC and optionally RF power supply 703 and associated electrical circuit. An activated carbon anode electrode 705, one or more cathode electrodes 707, and an insulator 708 are disposed within housing 702. Cathodes 707 preferably include one or more longitudinally elongated, laterally spaced apart wires or rods, which are electrically connected together by wires or traces 710 as part of the circuit. In one example, each cathode wire is approximately 1 mm thick and 0.5 m long, which adjacent of the cathode wires being spaced apart approximately 12-25 mm. In the presently illustrated version, each cathode wire has a circular cross-sectional shape. The cathode wires are generally parallel and co-planar in the illustrated configuration, although it is alternately envisioned that they may be arranged in a curved or even cylindrical manner to laterally surround part or all of the anode.

Insulator 708 is preferably made from glass, ceramic, or polymers such as PET, PVC, polycarbonate, peek carbon fiber resin, or the like, and has a relatively high dielectric constant such as greater than 10. The insulator is flat and has an exemplary thickness of 1-12 mm. Insulator 708 is closer to, and more preferably in contact with, cathodes 707, while having a gap 713 between it and spaced apart anode 705. Optionally, an activated carbon layer 720 may be deposited on the anode-facing surface of insulator 708 to act as a working electrode with an opposite charge from the anode.

Anode is elongated in an angularly offset direction, such as perpendicular, relative to the longitudinal direction of cathodes 707. Anode 705 may have a curved cross-sectional shape, such as a circle or oval, or may have one or more flat cathode-facing surfaces with a generally polygonal cross-sectional shape, such as a rectangle, hexagon, square or the like. The cathode centerline-to-anode centerline thickness is preferably 1-10 mm depending on the desired volume of fluid and ion removal speed within the housing. The smaller the thickness distance, the greater the nonuniform electrical field and associated greater molecule size reduction and ion removal.

The liquid, such as water or solvents, flows along direction 722 in a nonuniform electric field 724 between the cathode and anode 705. Electric field 724 is stronger closer to the wire electrode 707 and weaker closer to the anode 705, and the voltage may optionally be automatically reversed during use to capture different ions from the liquid. The liquid also acts as a dielectric in addition to the insulator. This electrode deionizer 701 advantageously creates a non-uniform electric field as well as electrophoresis and dielectrophoresis to reduce the size of and move the ionic molecules for trapping by the activated carbon electrodes. This system is well suited for use with large volume and continuously flowing liquid or even gaseous (e.g., smokestack) fluid.

Alternately, the fluid flow direction may be parallel to the elongation direction of anode 705. Optionally, the voltage may be reversed to allow liquid flushing or removing of trapped ions from the electrodes as part of a cleaning cycle.

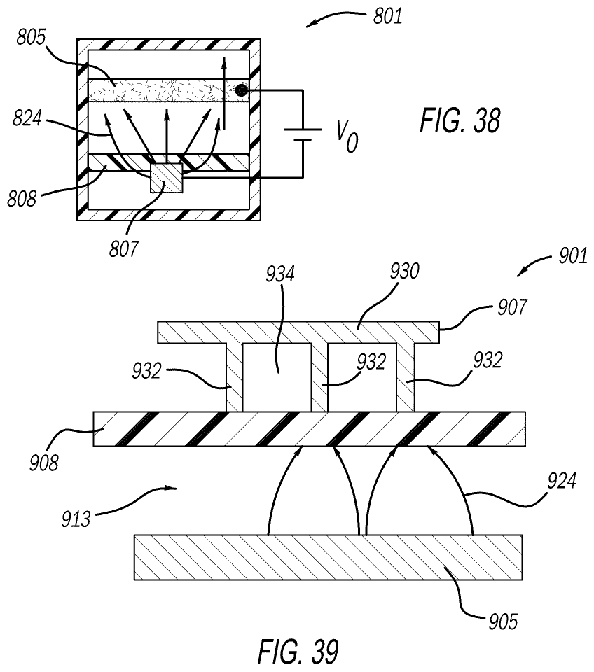

FIG. 38 shows another embodiment electrode deionizer apparatus 801 including at least one wire cathode 807, a perpendicularly oriented anode 805 and an insulator 808 therebetween. In this construction, however, each cathode wire 807 has a generally rectangular shape, and more preferably a generally square shape with flat lateral faces. This creates a slightly different pattern to its nonuniform electrical field 824. Otherwise, this embodiment operates similar to that of FIGS. 36 and 37.

Finally, reference should be made to another variation shown in FIG. 39. This embodiment of the present electrode deionizer apparatus 901 includes an activated carbon anode 905, a cathode 907 and an insulator 908 therebetween. However, this cathode 907 has a laterally enlarged base 930 with walls 932 projecting therefrom in a laterally spaced apart and generally parallel manner. Gaps 934 are between each pair of walls 932 and distal ends of the walls contact against a surface of insulator 908. A nonuniform electric field 924 spans from anode 905, through a fluid filled gap 913, and to cathode 907. Otherwise, this construction operates similar to the previously discussed embodiments.

While various embodiments have been disclosed, it should be appreciated that additional variations of the electrode apparatus and method are also envisioned. For example, additional or different hardware components may be used although certain of the present advantages may not be fully realized. An anode made of porous metals or other electrically conductive materials can be also used. Furthermore, while the preferred fluid discussed herein is a liquid, such as water or a solvent, the present apparatus and method can alternately be used with a gaseous fluid. It is envisioned that any of the embodiments described herein can be part of a removable and replaceable cartridge of the type shown in FIG. 34. While certain electrode and pipe shapes have been disclosed it should be appreciated that alternate shapes may be used (for example, octagonal, oval or other cross-sectional shapes that create a non-uniform electric field) although all of the present advantages may not be fully achieved. It is also noteworthy that any of the preceding features may be interchanged and intermixed with any of the others. Accordingly, any and/or all of the dependent claims may depend from all of their preceding claims and may be combined together in any combination. Variations are not to be regarded as a departure from the present disclosure, and all such modifications are entitled to be included within the scope and sprit of the present invention.

The invention claimed is:

1. A method for removing a polarized molecular cluster in a fluid, the method comprising:
(a) supplying a voltage between an anode and a cathode;
(b) creating an electric field between the anode and the cathode;
(c) placing the fluid within a gap between the anode and the cathode;
(d) creating electrophoresis forces between the anode and the cathode to cause ions of the polarized molecular cluster in the fluid to move to the anode and also creating dielectrophoresis forces on dipoles of the polarized molecular cluster;
(e) reducing a size of the polarized molecular cluster with the dielectrophoresis forces; and
(e) trapping the reduced size polarized molecules in activated carbon on the anode.

2. The method of claim 1, wherein the cathode comprises multiple spaced apart and substantially parallel wires, further comprising causing a non-uniform electric field to flow through the fluid from the cathode wires to the anode.

3. The method of claim 1, further comprising:
an insulator located between the cathode and the anode; and
flowing the fluid, which is a liquid, between the insulator and the anode.

4. The method of claim 1, further comprising:
causing a non-uniform electric field to flow through the fluid from the cathode, which comprises multiple spaced apart and elongated wires, to the anode which has an elongation direction angularly offset from the cathode wires;
flowing the fluid between an insulator and the anode, the insulator being located between the cathode and the anode, and having a dielectric constant greater than 10;
powering the anode with 10-1,000 volts to cause ion movement by the combined electrophoresis and dielectrophoresis forces;
the activated carbon includes biochar; and
the fluid is a liquid.

5. The method of claim 1, wherein:
the anode comprises concentrically arranged at least first and second cylindrical anodes;
the cathode comprises concentrically arranged at least first and second cylindrical cathodes; and
the first and second cylindrical anodes are located between the cylindrical cathodes;
further comprising flowing the fluid between the cylindrical cathodes and between the cylindrical anodes, while moving the reduced size polarized molecules toward the anodes and removing the reduced size polarized molecules from the fluid.

6. The method of claim 1, wherein the placing the fluid includes flowing drinking water through the gap between the cathode and the anode, which are attached to a water faucet.

7. The method of claim 1, wherein the placing the fluid includes flowing water through an industrial water treatment piping system to which the anode and the cathode are attached, the system comprising a contaminated supply reservoir, an electrode-based precipitator, a water pump, sensors, and pipes.

8. The method of claim 1, wherein:
the cathode is longitudinally elongated and substantially cylindrical;
the gap is cylindrical and surrounds the anode; and
the cathode and anode are part of a cartridge comprising an external housing, gaskets, and fasteners;
further comprising stopping the fluid from flowing in the gap;
stopping DC power supply to the anode;
thereafter removing the cartridge from a stationary water treatment facility by disengaging the fasteners;
thereafter assembling a replacement cartridge, comprising an anode and cathode, into the stationary water treatment facility;
thereafter supplying DC power to the anode of the replacement cartridge; and
after the assembling, resuming flowing the fluid through a gap in the replacement cartridge.

9. The method of claim 1, further comprising the trapping the smaller molecules includes removing PFAS molecules from the fluid by driving or pulling the PFAS molecules toward the anode without mechanical filtering.

10. The method of claim 1, further comprising simultaneously supplying at least 100 KHz of RF power and the voltage, which is DC, to the anode.

11. A method for removing an ionic cluster in a liquid, the method comprising:
(a) powering at least one of multiple electrodes, with 10-1,000 volts;
(b) creating an electric field between the electrodes;
(c) flowing the liquid between the electrodes;
(d) creating electrophoresis forces on the ionic cluster in the liquid between the electrodes;
(e) creating dielectrophoresis forces on the ionic cluster in the liquid between the electrodes;
(f) reducing a size of the ionic cluster in the liquid between the electrodes; and
(g) causing at least a PFAS molecule of the ionic cluster to move toward activated carbon on the anode.

12. The method of claim 11, wherein the electrodes comprise multiple spaced apart and substantially parallel cathode wires, further comprising causing a non-uniform electric field to flow through the liquid from the cathode wires to the at least one of the electrodes which is at least one anode.

13. The method of claim 12, further comprising:
an insulator located between the cathode wires and the at least one anode, the cathode wires being substantially coplanar and elongated in a direction offset from an elongation direction of the at least one anode; and
flowing the fluid, which is a liquid, between the insulator and the at least one anode.

14. The method of claim 11, further comprising:
causing a non-uniform electric field to flow through the liquid;
flowing the fluid between an insulator and at least one of the electrodes, the insulator having a dielectric constant greater than 10;
the activated carbon includes plasma-activated biochar; and
the fluid includes water.

15. The method of claim 11, wherein:
at least one of the electrodes comprises concentrically arranged at least first and second cylindrical anodes;
at least another of the electrodes comprises concentrically arranged at least first and second cylindrical cathodes; and
the first and second cylindrical anodes are located between the cylindrical cathodes;
further comprising flowing the liquid between the cylindrical cathodes and between the cylindrical anodes, while moving the PFAS molecule toward the anodes and removing the PFAS molecule from the liquid.

16. The method of claim 11, wherein:
the electrodes are part of a cartridge comprising an external housing, gaskets, and fasteners;
further comprising:
stopping the liquid from flowing between the electrodes;
stopping DC power supply to the at least one of the electrodes;
thereafter removing the cartridge from a liquid-carrying pipe by disengaging the fasteners;
thereafter assembling a replacement cartridge onto the pipe;
thereafter supplying DC power to at least one of the electrodes of the replacement cartridge; and
after the assembling, resuming flowing the liquid between the electrodes in the replacement cartridge.

17. The method of claim 11, further comprising simultaneously supplying RF power and the voltage, which is DC, to an anode of the electrodes, during the flowing of the liquid.

18. A method for removing a polarized molecular cluster in a fluid, the method comprising:
(a) supplying a voltage between electrodes comprising an anode and a cathode,
the cathode comprising multiple spaced apart and substantially parallel cathode wires, and
the anode having an elongation direction offset oriented from an elongation direction of the cathode wires;
(b) creating an electric field between the anode and the cathode wires;
(c) flowing the fluid within a gap between the anode and the cathode wires; and
(d) creating electrophoresis forces between the anode and the cathode wires to cause at least a portion of the polarized molecular cluster in the fluid to move to the anode and also creating dielectrophoresis forces on at least a portion of the polarized molecular cluster.

19. The method of claim 18, further comprising:
causing a non-uniform electric field through the fluid from the cathode wires to the anode;
reducing a size of the polarized molecules; and
trapping the reduced size polarized molecules in activated carbon on the anode.

20. The method of claim 18, further comprising:
flowing the fluid between an insulator and the anode, the insulator having a dielectric constant less than 10; and
the fluid including a liquid; and
trapping PFAS of the polarized molecules by the anode.

21. The method of claim 18, further comprising:
flowing the fluid between a dielectric insulator and the anode; and
the insulator contacting against spaced apart walls of the cathode projecting from a laterally enlarged base of the cathode.

22. The method of claim 18, wherein at least one of the electrodes has a curved cross-sectional shape.

23. The method of claim 18, wherein at least one of the electrodes has a substantially polygonal cross-sectional shape with a flat face facing another of the electrodes.

24. The method of claim 18, wherein the electrodes are located within a cartridge including gaskets and a fastener, further comprising detaching the fastener to remove the cartridge from a fluid-carrying pipe.

25. An electrode deionizer apparatus comprising:
(a) a cathode comprising multiple spaced apart and substantially parallel cathode wires;
(b) an anode having an elongation direction offset oriented from an elongation direction of the cathode wires;
(b) a DC power supply connected to the anode;
(c) an RF power supply connected to the anode;
(d) a housing containing the cathode wires and the anode;
(e) a pipe coupled to the housing and being configured to flow a liquid within a gap between the anode and the cathode wires; and
(f) activated carbon, located on the anode, configured to remove ionic molecules from the liquid due to dielectrophoresis created between the anode and the cathode.
